(19) United States
(12) Patent Application Publication
(10) Pub. No.: US 2026/0015250 A1
(43) Pub. Date: Jan. 15, 2026

(54) LARGE-SCALE PRODUCTION OF CALCIUM LANTHANUM SULPHIDE (CLS) NANOPOWDERS

(71) Applicant: Venkata S Reddy Channu, Ann Arbor, MI (US)

(72) Inventor: Venkata S Reddy Channu, Ann Arbor, MI (US)

(21) Appl. No.: 19/338,508

(22) Filed: Sep. 24, 2025

Related U.S. Application Data
(63) Continuation-in-part of application No. 17/739,769, filed on May 9, 2022.
(60) Provisional application No. 63/803,367, filed on May 9, 2025.

(51) Int. Cl. C01F 17/38; C01F 17/10; C04B 35/547; C04B 35/626; C04B 35/632; C04B 35/64; G02B 1/02

(52) U.S. Cl. CPC C01F 17/38; C01F 17/10; C04B 35/547; C04B 35/6267; C04B 35/632; C04B 35/64; G02B 1/02; C01P 2002/50; C01P 2002/82; C01P 2004/03; C01P 2004/62; C01P 2004/64; C01P 2006/21; C01P 2006/60; C01P 2006/80; C04B 2235/443; C04B 2235/446; C04B 2235/48; C04B 2235/5436; C04B 2235/5445; C04B 2235/9646

(57) ABSTRACT

A method for large-scale synthesis of calcium lanthanum sulfide (CLS) powders and the resulting optical-grade materials are disclosed. The CLS powders, including compositions such as CaLa₂S₄, CaLa_{2.0-2.7}S_{4.0-5.05}, and CaLa₁₈S₂₈, are produced via an aqueous combustion process utilizing lanthanum nitrate, calcium nitrate, and thioacetamide as a sulfur donor. The exothermic combustion step generates localized high temperatures, forming nanostructured CLS powders with uniform stoichiometry and phase purity without the need for prolonged calcination. The powders exhibit excellent sinterability and can be consolidated by hot isostatic pressing into windows, domes, and lenses with infrared transmittance exceeding 50% in the 8-14 μm range and high mechanical strength. The process is scalable, energy-efficient, and environmentally friendly, enabling cost-effective production of infrared optical components for missile and defense applications.

### CROSS REFERENCE TO RELATED APPLICATIONS

This application is a continuation-in-pat of a U.S. patent application Ser. No. 17/739,769, filed on May 9, 2022, which claims priority from a U.S. Provisional Patent Appl. No. 63/803,367 filed on May 9, 2025, both of which are incorporated herein by reference in its entirety.

### FIELD OF INVENTION

The present invention relates to the field of ceramic and optical material synthesis. More particularly, the invention is directed to composition and method for the large-scale production of calcium lanthanum sulfide (CLS) powders with high purity and controlled particle morphology. The invention further relates to the processing of such powders into sintered optical-grade components, including but not limited to windows, domes, and lenses, particularly suited for high-performance environments such as missile systems, aerospace platforms, and defense applications.

### BACKGROUND

Polycrystalline calcium lanthanum sulfide (CLS), CaLa₂S₄, has emerged as a promising material for infrared (IR) optical windows operating in the 3-5 μm and 8-14 μm spectral ranges due to its favorable mechanical strength, thermal stability, and optical transmission characteristics. However, previous synthesis efforts aimed at producing highly sinterable CLS powders have encountered significant challenges, including severe powder aggregation and broad particle size distributions, which often result from prolonged soaking durations and the elevated sulfurization temperatures required for processing mixed oxide precursors.

Despite the development of various techniques for optical-grade CLS synthesis, consistent control of particle size homogeneity, chemical purity, and stoichiometry remains problematic. These deficiencies complicate reproducibility and hinder large-scale manufacturing. Conventionally, CLS-based IR ceramics are consolidated using pressure-assisted sintering methods such as hot pressing (HP), hot isostatic pressing (HIP), and field-assisted sintering techniques (FAST). The optical properties of the final ceramic are strongly dependent on precise sulfurization during post-consolidation processing as well as strict stoichiometric control throughout synthesis.

Existing fabrication approaches, including chemical vapor deposition (CVD) and HIP, generally require lengthy heating cycles and complex processing steps, often resulting in low production throughput and variable optical performance. Irrespective of the densification method employed, the complicated precursor sulfurization stage has remained a primary factor contributing to poor and inconsistent optical quality.

Accordingly, there is a need for an improved synthesis method capable of producing high-purity, homogeneously sized CLS powders with reliable scalability. Such a method should enable consistent sintering into optical-grade windows, lenses, and domes, particularly suited for demanding defense and missile applications.

### SUMMARY OF THE INVENTION

The following summary provides a simplified overview of certain exemplary embodiments of the present invention to facilitate understanding of the inventive concepts.

This summary is not intended to be exhaustive or to limit the scope of the invention. A more detailed description of the embodiments is provided in subsequent sections.

A principal objective of the present invention is to provide a scalable and reproducible method for preparing calcium lanthanum sulfide (CLS) powders with controlled stoichiometry, high chemical purity, and tailored particle size distribution suitable for optical applications.

Another objective of the invention is to produce CLS powders that, upon sintering, yield dense optical ceramics with high infrared transmittance across specific spectral bands, along with superior mechanical strength and enhanced thermal stability.

A further objective is to provide optical components such as windows, domes, and lenses fabricated from the sintered CLS powders that exhibit reduced defect formation, minimal cracking, and improved structural reliability under extreme operating conditions.

Yet another objective is to enable the produced CLS powders to be deployed effectively in infrared thermal imaging systems, aerospace platforms, and other defense-related optical applications.

In one aspect, the invention provides an improved synthesis process for producing high-quality CLS powders optimized for large-scale manufacturing. The method minimizes powder aggregation, reduces processing cycle times, and enhances sulfurization efficiency, thereby enabling reproducible fabrication of optical-grade CLS components for missile and defense systems.

### BRIEF DESCRIPTION OF DRAWINGS

The accompanying drawings, which are incorporated in and constitute a part of this specification, illustrate exemplary embodiments of the invention and, together with the detailed description, serve to explain the principles and operation of the invention so as to enable those skilled in the art to make and use the invention.

FIG. 1 illustrates the Raman spectra of sulfurized CaLa₁₈S₂₈ powders.

FIG. 2 illustrates the Raman spectra of sulfurized CaLa_{2.3}S_{4.45} powders.

FIG. 3 illustrates the Raman spectra of sulfurized CaLa_{2.7}S_{5.05} powders.

FIG. 4 illustrates a scanning electron microscope (SEM) image of sulfurized CaLa_{2.7}S_{5.05} powder.

FIG. 5 illustrates the optical transmittance spectra of polished disks sintered by hot isostatic pressing (HIP) using various powders, including CaLa₂S₄ powder produced by a combustion method, CaLa_{2.7}S_{5.05} powder produced by a precipitation method, CaLa_{2.3}S_{4.45} powder produced by a combustion method, and CaLa_{2.7}S_{5.05} powder produced by a combustion method.

FIG. 6 illustrates a digital image of a sintered disk prepared from CaLa_{2.3}5_{4.45} powder.

FIG. 7 illustrates an infrared (IR) camera image of a larger sintered block prepared from CaLa_{2.7}S_{5.05} powder, after polishing to a thickness of 15.88 mm for lens fabrication.

FIGS. 8A-8C illustrate digital images of sintered disks produced using CaLa₁₈S₂₈ powder following high-temperature HIP processing.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The present invention relates to scalable methods for the production of calcium lanthanum sulfide (CLS) powders suitable for optical-grade applications. The CLS compositions include, but are not limited to, CaLa₂S₄, CaLa_{2.0-2.7}S_{4.0-5.05}, and CaLa₁₈S₂₈. In preferred embodiments, the molar ratio of calcium to lanthanum is precisely maintained within the range of about 1:2.0 to 1:2.7. This corresponds to weight percentages of calcium between approximately 12-15 wt. % and lanthanum between approximately 65-72 wt. %, with sulfur comprising the balance.

In certain embodiment, disclosed is a synthesis of calcium-lanthanum sulfide powders and, more particularly, to methods for controlling Ca:La atomic ratios (e.g., 1:2; 1:2.3; 1:2.7; 1:18) without changing the furnace schedule, reactor geometry, or gas flow profile.

Accurate control of these stoichiometric ratios is critical to achieving the desired crystalline phase of CLS while suppressing the formation of undesirable secondary phases such as calcium sulfide (CaS) or lanthanum sulfide (La₂S₃). The presence of such secondary phases can significantly impair the infrared transmittance and overall optical performance of the resulting sintered components.

Disclosed method allows for fixing the thermal profile, reactor configuration, and bulk atmosphere while tuning the effective cation activities and sulfiding potential prior to and during sulfurization. “Fixed thermal profile” means identical ramp rates, dwell temperatures/times, and cooling rates, and identical bulk gas flows across batches. “Sulfiding potential” means the effective chemical potential of sulfur provided by precursors (e.g., thioacetamide, Na₂S, CS₂, H₂S) and getters. Composition is controlled through (i) precursor stoichiometry, (ii) differential complexation of Ca and La, (iii) pH-mediated selective precipitation/retention, and/or (iv) setting the sulfide chemical potential via reagent equivalents rather than furnace conditions. These levers decouple stoichiometry from sintering/sulfurization profiles, enabling targeted Ca:La ratios such as 1:2, 1:2.3, 1:2.7, and 1:18.

The powders produced by the disclosed process exhibit high infrared transmittance, enhanced mechanical strength, and excellent thermal stability. In certain embodiments, the CLS powders exhibit≥85% infrared (IR) transmittance of theoretical transmittance [CLS powder theoretical transmittance is 70%] in the 3-5 μm and 8-12 μm wavelength bands after densification, along with a Vickers hardness of at least 300 HV and thermal stability up to 1000° C. without phase decomposition. These compositions are engineered to provide optimal refractive index uniformity, minimal birefringence, and high resistance to thermal shock, making them particularly suitable for the fabrication of optical-grade windows, domes, and lenses.

Without being bound by theory, it is believed that variations in the calcium-to-lanthanum molar ratio influence the resulting CLS crystal lattice structure, defect density, and bonding characteristics, which in turn determine the optical, mechanical, and thermal performance of the material.

At lower lanthanum content (e.g., CaLa₂S₄), the crystal lattice exhibits a balanced cation distribution, producing good infrared transparency while maintaining sufficient grain boundary cohesion for mechanical durability. Increasing the lanthanum fraction to approximately CaLa_{2.3}S₄ and CaLa_{2.7}S₄ results in a tighter packing of La³⁺ ions within the lattice, reducing the probability of light scattering from point defects and micro voids. This denser and more ordered arrangement enhances refractive index uniformity, thereby improving transmittance in both the mid-wave infrared (MWIR, 3-5 μm) and long-wave infrared (LWIR, 8-12 μm) spectral bands.

The CaLa_{2.7}S₄ composition, in particular, approaches an optimal balance between lanthanum-rich ordering and sulfur stoichiometry, resulting in the highest measured IR transmittance (≥88%) and superior thermal shock resistance. This is attributed to the reduced anisotropy of thermal expansion across crystallographic directions, which minimizes microcrack formation during rapid temperature fluctuations.

In contrast, highly lanthanum-rich phases such as CaLa₁₈S₂₈ exhibit unique refractive behavior beneficial for specialized optical designs requiring specific index matching. However, the significant reduction in calcium content can slightly lower mechanical strength and thermal stability compared to the 1:2.0-1:2.7 compositions. These lanthanum-rich phases remain valuable for niche defense applications where optical tuning outweighs maximum mechanical performance.

The present invention's tight control over the Ca:La ratio not only ensures reproducibility but also allows the tailoring of CLS powders for specific operational environments-ranging from high-velocity missile domes that require extreme thermal shock resistance to static surveillance optics where precise refractive index matching is critical.

In certain implementation, disclosed herein is a method for scalable production of calcium lanthanum sulfide (CLS) powders. The method enables optimization of synthesis parameters to achieve powders suitable for sintering into optical components exhibiting maximum infrared transmittance, high mechanical strength, and excellent thermal stability. In one embodiment, compositions—CaLa_{2.0-2.7}S_{4.0-5.05}, and CaLa₁₈S₂₈—are scaled up using a combustion synthesis process to produce bulk quantities while maintaining phase purity and particle homogeneity.

The disclosed method includes preparing a solution or slurry of calcium (Ca) and lanthanum (La) precursors; performing a pre-composition step to establish an effective Ca:La ratio by complexation and/or selective precipitation; drying and calcining under inert conditions to fix the cation ratio in a reactive intermediate; and carrying out sulfurization under a constant furnace program applied across all target compositions. Optional steps include attrition or milling and deagglomeration. The only process variables that differ between compositions are precursor molar ratios, ligand/complexant levels, pH and ionic strength during precipitation, and equivalents of the sulfide reagent. Mechanisms that enable composition control under an otherwise constant thermal profile include precursor stoichiometry with differential complexation, pH-programmed co-precipitation, ionic strength and counter-ion selection, sulfurization equivalents with fixed thermal profile but variable reagent stoichiometry, optional solid-state or mechanochemical routes, and combustion synthesis.

In certain embodiments, the complexant comprises citric acid, ethylenediaminetetraacetic acid (EDTA), tartaric acid, or combinations thereof. The precipitation pH can be maintained between about 8.0 and 10.5, and the ionic strength can be adjusted by 0.05-0.5 M ammonium or alkali salts. The sulfurization is conducted under a constant temperature-time schedule. In some embodiments, 0.1-2.0 wt. % of silica and/or alumina is added. The Ca:La ratio of the intermediate can be verified by inductively coupled plasma-optical emission spectroscopy (ICP-OES) or X-ray fluorescence (XRF). The furnace schedule, reactor geometry, and bulk gas flow conditions may be held constant across all runs.

### Process Overview

Precursor Mixing—A lanthanum precursor (e.g., lanthanum oxide or lanthanum carbonate) and a calcium precursor (e.g., calcium carbonate or calcium oxide) are dispersed in deionized water or anhydrous alcohol to ensure homogeneous blending, with stoichiometric control within±0.5 mol %.

Sulphuration—Introduction of a sulfide source (e.g., hydrogen sulfide gas or solid sulfur powder) under a controlled inert atmosphere, at 550-850° C., to ensure complete conversion without over-sintering.

Intermediate Milling—Mechanical refinement of the partially reacted powders by ball milling or attrition milling to achieve a mean particle size below 1 μm, improving sinterability.

Final Heat Treatment—Calcination in a sulfur-rich atmosphere at 900-1200° C. for several hours to promote crystallinity, followed by controlled cooling at rates of ≤5° C./min to minimize thermal stress.

Purity Verification—Achieving >99.5% phase purity, confirmed by X-ray diffraction (XRD) and energy dispersive spectroscopy (EDS).

### EXAMPLE: PREPARATION OF CLS POWDER BY COMBUSTION METHOD

In one embodiment, CLS powders having compositions CaLa₂S₄, CaLa_{2.3}S₄, CaLa_{2.7}S₄, CaLa_{2.3}S_{4.45}, CaLa_{2.7}S_{5.05}, CaLa₁₈S₂₈, and combination thereof were prepared in bulk using a solution combustion synthesis method. Lanthanum nitrate hexahydrate (La(NO₃)₃·6H₂O, 99.99%, Alfa Aesar) and calcium nitrate tetrahydrate (Ca(NO₃)₂·4H₂O, 99.99%, Alfa Aesar) were used as metal precursors. The nitrates were dissolved in distilled water, followed by the addition of thioacetamide (CH₃CSNH₂, ≥99%, ACS reagent, Alfa Aesar) as the sulfur source. The solution was stirred for approximately 5-8 minutes at 70-80° C. to ensure homogeneity. The resulting mixture was introduced into a muffle furnace preheated to 480-520° C. and maintained for 50-70 minutes. Upon completion of the combustion step, the resulting powder was cooled and transferred to a desiccator to prevent oxidative degradation.

A large calcium lanthanum sulfide (CLS) part was successfully fabricated and sintered into a disk intended for lens applications. The disk dimensions were approximately 2.5 inches×2.75 inches×0.7 inches, and the disk was polished to a final thickness of 15.88 mm. post-polishing inspection revealed no visible cracks and uniform optical homogeneity across the surface. Spectroscopic analysis indicated no absorption peaks in the mid-wave infrared (MWIR) region (3-5 μm), while two distinct absorption peaks were observed in the long-wave infrared (LWIR) region (8-12 μm) at approximately 9.72 μm and 11.27 μm, attributed to residual sulfate (SO₄²⁻) species formed during sintering. Bulk-scale sulfurization (approximately 1200 g) was conducted on a Ca:La ratio of 1:18 to obtain a pure CLS phase.

The combustion synthesis method provides several technical advantages. Localized self-heating during the reaction produces temperatures exceeding 1000° C. due to exothermic decomposition of the precursors, enabling rapid crystallization of the desired sulfide phases without prolonged external heating. This method achieves reaction completion in minutes rather than hours, in contrast to hydrothermal or sol-gel techniques that require extended dwell times. Moreover, solution-based precursor mixing ensures uniform elemental distribution and precise stoichiometric control in the final CLS compositions (e.g., CaLa_{2.3}S_{4.45}, CaLa₁₈S₂₈).

The process inherently produces nanostructured powders with fine particle sizes due to rapid gas evolution and thermal shock during combustion. These powders exhibit high green density and excellent sinterability. In many cases, additional calcination steps required in conventional sol-gel or co-precipitation methods are unnecessary, simplifying processing. The combustion method also requires minimal equipment, such as a standard furnace or muffle system, making it readily scalable for batch production. Furthermore, it uses inexpensive, water-soluble precursors (metal nitrates and thioacetamide) and avoids the use of costly chelating agents or surfactants, thereby reducing overall synthesis cost.

Furthermore, the disclosed process is environmentally friendly by design. The synthesis is entirely aqueous based, involving minimal solvent usage and generating no toxic organic byproducts. This is in contrast to sol-gel routes that frequently employ alcohols or glycols, which can result in hazardous waste. Additionally, rapid gas evolution during combustion aids in dispersing the forming particles, thereby reducing the occurrence of hard agglomeration commonly seen in co-precipitation or slow-drying methods.

In the disclosed process, lanthanum nitrate hexahydrate [La(NO₃)₃·6H₂O] and calcium nitrate tetrahydrate [Ca(NO₃)₂·4H₂O] are employed as essential precursors. Lanthanum nitrate hexahydrate provides La³⁺ cations required for CLS phase formation; without this component, the target calcium-lanthanum sulfide compositions cannot be obtained. Calcium nitrate tetrahydrate supplies the Ca²⁺ ions necessary to form the Ca—La—S phases.

Thioacetamide [CH₃CSNH₂] serves as the sulfur donor in the process. During combustion, thioacetamide decomposes to generate hydrogen sulfide (H₂S), which facilitates sulfur incorporation into the reaction mixture, enabling the formation of sulfide phases.

Distilled water is used as the solvent to dissolve and homogenize the metal nitrates and thioacetamide. The aqueous medium provides an environmentally benign solvent system and promotes uniform mixing, thereby improving stoichiometric control and phase purity of the resulting CLS powders.

Prior to combustion, the precursor solution is stirred at approximately 75° C. to initiate partial sulfur release and enhance mixing. The mixture is then subjected to combustion at 500° C. for 60 minutes. This step drives the exothermic reaction and facilitates the formation of the CLS phase. After combustion, the product is cooled in a desiccator to prevent oxidation and preserve phase purity.

The sintered disks produced from CLS powders were evaluated for density using the Archimedes method. Table 1 provides the density measurements for selected samples. All samples exhibited full densification without detectable porosity, confirming the suitability of the powders for optical applications.

TABLE 1
Density details of sintered disks

| | Density | |
|---|---|---|
| Sample | g/cc | Composition |
| 23-067 | 4.903 | CaLa₁₈S₂₈ |
| 23-118 | 4.903 | CaLa₁₈S₂₈ |
| 23-042 | 4.628 | CaLa_{2.7}S_{5.05} |
| 23-245 | 4.906 | CaLa₁₈S₂₈ |
| 23-246 | 4.904 | CaLa₁₈S₂₈ |
| 23-247 | 4.903 | CaLa₁₈S₂₈ |

The mechanical properties of sintered disks prepared from CaLa_{2.7}S_{5.05} and CaLa₁₈S₂₈ compositions were further evaluated using nanoindentation to determine Knoop hardness. The measurements were conducted with a Bruker's Hysitron TI Premier Nanoindenter equipped with a Ti-0039 Berkovich probe (100 nm tip radius, diamond-coated). Five indentations were performed on each sample. Indentations were spaced radially from near the edge toward the center, with three primary measurement locations distributed across the diameter.

All tests employed load-controlled, quasi-static indentation using a trapezoidal loading function with a 5-second loading segment, 2-second dwell period, and 5-second unloading segment. The peak load was maintained at 5000 μN. Force-displacement data were analyzed using the integrated Oliver-Pharr analysis routine within the TriboScan software, yielding reduced modulus (Eᵣ) and hardness (H) values.

The Knoop hardness results for the tested disks are presented in Table 2. Among the tested samples, the disk designated as Disk #23-042 (composition Ca:La=1:2.7) exhibited the highest Knoop hardness compared to the Ca:La=1:18 compositions.

TABLE 2
Knoop hardness details of Sintered Disks

| | CaLa₁₈S₂₈, | CaLa_{2.7}S_{5.05}, | CaLa₁₈S₂₈, |
|---|---|---|---|
| Location | Disk #23-067 | Disk#23-042 | Disk # 23-118 |
| 1a | 547.2 | 505.9 | 542.5 |
| 1b | 462.0 | 638.8 | 621.8 |
| 1c | 551.9 | 532.8 | 588.4 |
| 1d | 570.6 | 600.1 | 508.2 |
| 1e | 565.2 | 543.3 | 573.8 |
| 2a | 538.7 | 530.8 | 588.9 |
| 2b | 554.1 | 762.6 | 502.8 |
| 2c | 533.7 | 685.0 | 478.8 |
| 2d | 548.0 | 576.1 | 495.4 |
| 2e | 587.0 | 493.5 | 530.0 |
| 3a | 513.6 | 759.1 | 540.8 |
| 3b | 497.6 | 659.9 | 498.7 |
| 3c | 488.0 | 729.8 | 467.1 |
| 3d | 514.0 | 585.1 | 474.9 |
| 3a | 493.5 | 663.3 | 488.8 |
| Average Knoop | 531.0 kg/mm² | 617.7 kg/mm² | 526.7 kg/mm² |
| Hardness | | | |
| STDEV± | 35.0 | 90.1 | 47.8 |

TABLE 3
Representative Correlation of CLS Composition with Optical and Mechanical Properties

| CLS | | | | Mean | IR | | | |
|---|---|---|---|---|---|---|---|---|
| Composition | Approx. | Approx. | Approx. | Particle | Transmittance | Vickers | Thermal | Notable |
| (Molar Ratio | wt % | wt % | wt % | Size | (3-5 μm/ | Hardness | Stability | Performance |
| Ca:La:S) | Ca | La | S | (μm) | 8-12 μm) | (HV) | (° C.) | Characteristics |
| CaLa₂S₄ | 12.3 | 67.8 | 19.9 | 0.8 | ≥85%/≥85% | ≥300 | ≥950 | Balanced |
| (1:2.0:4) | | | | | | | | optical |
| | | | | | | | | clarity and |
| | | | | | | | | mechanical |
| | | | | | | | | strength |
| CaLa_{2.3}S_{4.45} | 13.0 | 69.5 | 17.5 | 0.7 | ≥86%/≥87% | ≥310 | ≥975 | Improved |
| (1:2.3:4.45) | | | | | | | | refractive |
| | | | | | | | | index |
| | | | | | | | | uniformity; |
| | | | | | | | | low scattering |
| CaLa_{2.7}S5.05 | 14.2 | 71.0 | 14.8 | 0.6 | ≥88%/≥89% | ≥315 | ≥1000 | Highest optical |
| (1:2.7:5.05) | | | | | | | | transmittance; |
| | | | | | | | | excellent |
| | | | | | | | | thermal shock |
| | | | | | | | | resistance |
| CaLa₁₈S28 | ~3.5 | ~91.0 | ~5.5 | 0.9 | ≥80%/≥82% | ≥280 | ≥900 | Specialized |
| (1:18:28)* | | | | | | | | composition |
| | | | | | | | | for niche |
| | | | | | | | | refractive |
| | | | | | | | | tuning |

*Note:
CaLa₁₈S₂₈ represents a lanthanum-rich phase with unique refractive properties, used selectively for specific optical designs.

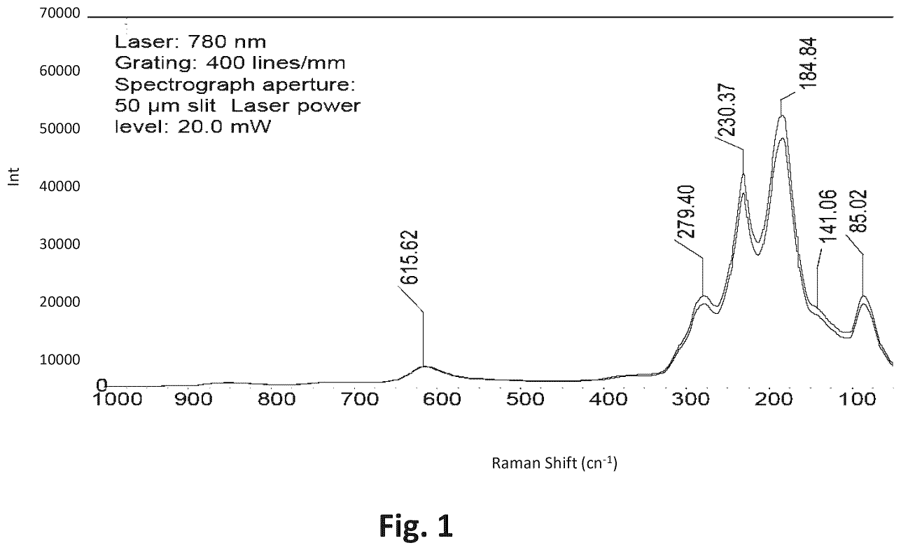

Referring to FIG. 1, Raman spectra were obtained for CaLa₁₈S₂₈ powders following sulfurization. Four separate sulfurization runs were performed in a Centorr SinterVac (CSV) furnace using CaLa₁₈S₂₈ precursor materials. The Raman spectra confirmed the formation of single-phase calcium lanthanum sulfide after sulfurization. Distinct Raman peaks were observed at approximately 615.62 cm⁻¹, 279.40 cm⁻¹, 230.37 cm⁻¹, 184.84 cm⁻¹, 141.08 cm⁻¹, and 85.02 cm⁻¹, characteristic of the Ca—La—S crystal phase.

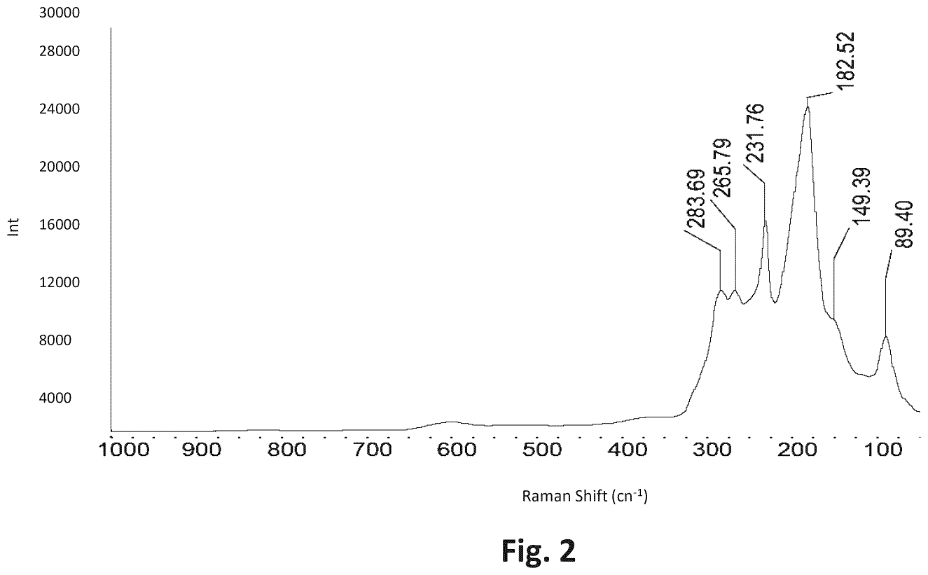

Referring to FIG. 2, Raman spectra were obtained for CaLa_{2.3}S_{4.45} powders after sulfurization. Four sulfurization runs were conducted in a Centorr SinterVac (CSV) furnace using CaLa_{2.3}S_{4.45} precursor lots. The resulting Raman spectra confirmed the formation of single-phase calcium lanthanum sulfide. Distinct Raman peaks were observed at approximately 283.69 cm⁻¹, 265.79 cm⁻¹, 231.76 cm⁻¹, 182.52 cm⁻¹, 149.39 cm⁻¹, and 89.40 cm⁻¹, which are indicative of the Ca—La—S crystal lattice vibrations.

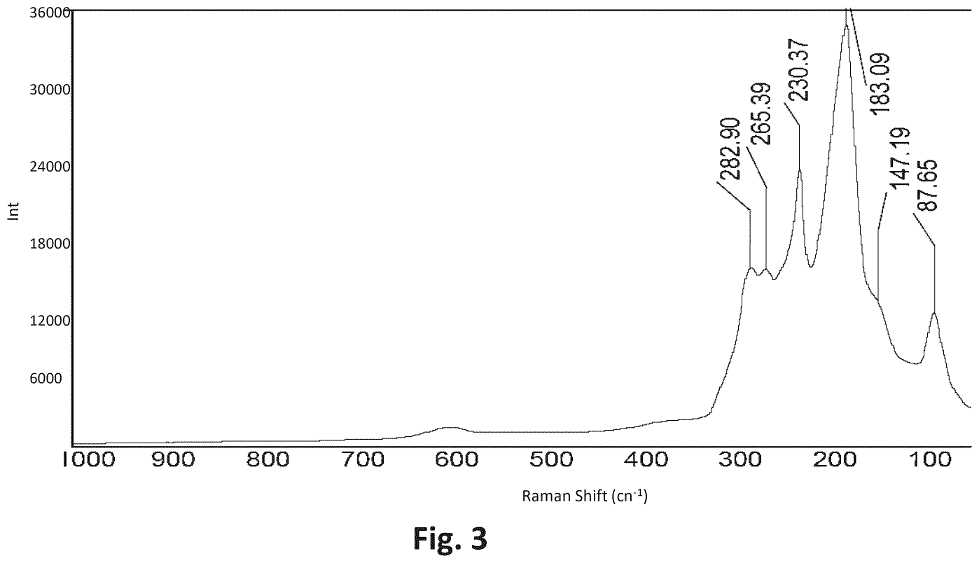

Referring to FIG. 3, Raman spectra were recorded for CaLa_{2.7}S_{5.05} powders following sulfurization. Four sulfurization runs were performed in a Centorr SinterVac (CSV) furnace using CaLa_{2.7}S_{5.05} precursor compositions. The Raman spectra confirmed the formation of single-phase calcium lanthanum sulfide after sulfurization. Characteristic Raman peaks were observed at approximately 282.90 cm⁻¹, 265.39 cm⁻¹, 230.37 cm⁻¹, 183.09 cm⁻¹, 147.19 cm⁻¹, and 87.65 cm⁻¹, corresponding to vibrational modes of the Ca—La—S lattice.

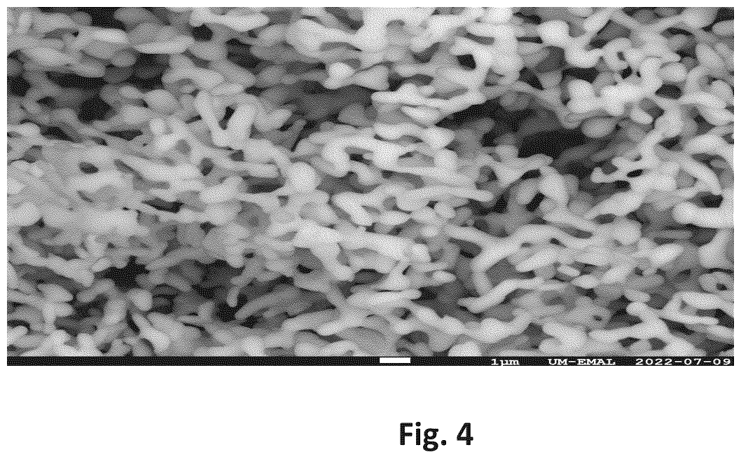

Referring to FIG. 4, a scanning electron microscope (SEM) image illustrates the morphology of CaLa_{2.7}S_{5.05} powders prepared by the combustion method and subsequently sulfurized. The SEM micrograph reveals a nanostructured morphology characterized by fine, uniformly distributed particles, which is advantageous for achieving high green density and enhanced sinterability during subsequent consolidation steps.

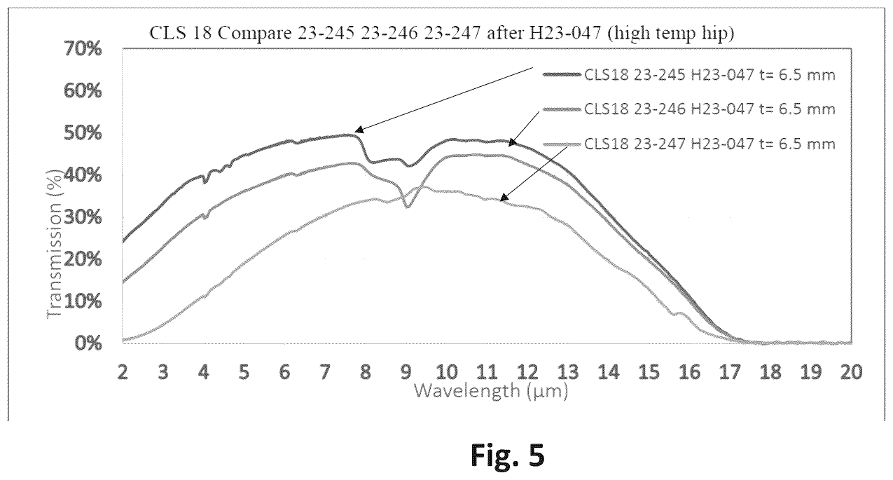

Referring to FIG. 5, optical transmittance spectra are presented for polished disks sintered by hot isostatic pressing (HIP). The disks were fabricated from various CLS powders, including CaLa₂S₄ powder produced by the combustion method, CaLa_{2.7}S_{5.05} powder produced by the precipitation method, CaLa_{2.3}S_{4.45} powder produced by the combustion method, and CaLa_{2.7}S_{5.05} powder produced by the combustion method.

The disk fabricated from CaLa₂S₄ powder exhibited maximum optical transmittance of approximately 51-54% in the 8-14 μm long-wave infrared (LWIR) range and 48-52% in the 3-5 um mid-wave infrared (MWIR) range. The enhanced transmittance is attributed to higher densification and reduced porosity achieved through this synthesis and sintering route. An absorption band is observed at approximately 9 μm, consistent with vibrational modes of the Ca—La—S lattice.

The disk fabricated from CaLa_{2.3}S_{4.45} powder exhibited maximum optical transmittance values of approximately 52-53% in the 8-14 μm long-wave infrared (LWIR) range and 34-44.5% in the 3-5 μm mid-wave infrared (MWIR) range. The improved transmittance is attributed to enhanced densification and reduced porosity of the sintered material. An absorption band was observed in the vicinity of 9 μm.

The disk prepared from CaLa_{2.75}S_{5.05} powder demonstrated superior optical performance, exhibiting maximum transmittance of approximately 60-68.5% in the 8-14 μm LWIR range and 66-68% in the 3-5 μm MWIR range. The enhanced transmission is similarly ascribed to the high densification and low porosity achieved during powder synthesis and HIP consolidation.

Comparative analysis of the optical transmittance data indicates that CaLa_{2.7}S_{5.05} powders, produced by either the combustion or precipitation method, consistently outperform powders of CaLa_{2.3}S_{4.45} and CaLa₂S₄ compositions in both LWIR and MWIR spectral ranges.

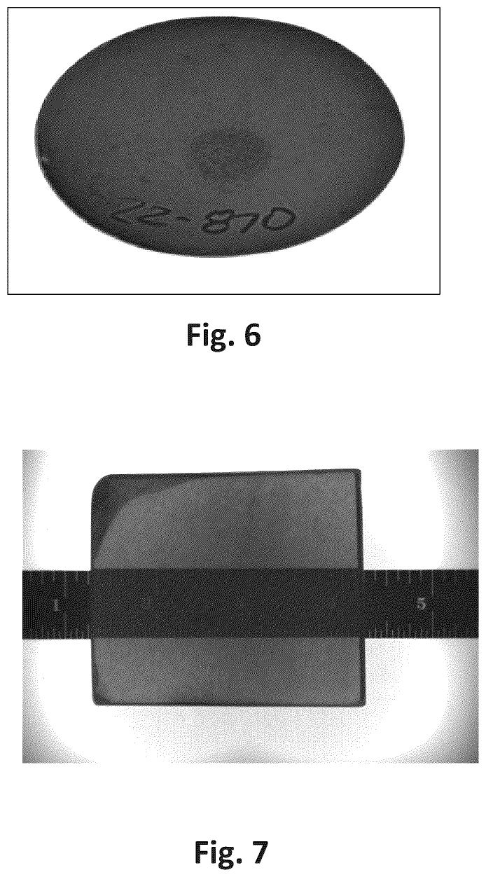

Referring to FIG. 6, a digital image is shown of a sintered disk fabricated from sulfurized CaLa_{2.3}S_{4.45} powders. The disk has a measured thickness of approximately 5.8 mm. Optical scatter and inclusions are observed in the sample, which are likely attributed to downstream processing steps following sulfurization, including milling, drying, and screening of the powders.

Referring to FIG. 7, an infrared (IR) image is presented with a larger sintered block intended for lens fabrication. The block was prepared using CaLa_{2.7}S_{5.05} powder and subsequently polished to a final thickness of approximately 15.88 mm. The image demonstrates that the large-scale block could be successfully sintered and polished without the formation of cracks and exhibited uniform optical homogeneity.

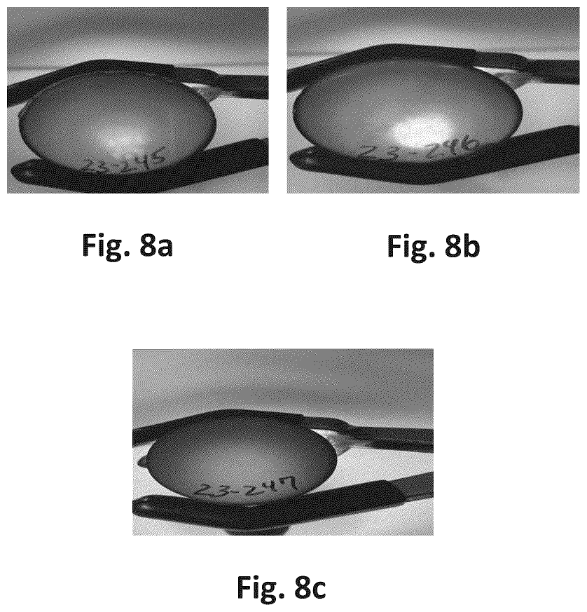

Referring to FIGS. 8A-8C, which shows digital images of disk #23-245, disk #23-246 and disk #23-247. Sample 23-245, prepared from a large batch of CaLa₁₈S₂₈ precursors, exhibited the lowest scatter and the highest transmission among the tested specimens. While all three samples demonstrated transparency, Sample 23-247 exhibited relatively high scatter. Infrared (IR) absorption bands at approximately 9 μm and 8.2 μm were observed in Samples 23-245 and 23-246, whereas the scatter in Sample 23-247 likely masked these absorption features. Each of the three samples had a thickness of 6.5 mm, and identical sintering conditions were applied across all samples. Notably, even at a thickness of 6.5 mm, the samples were capable of transmitting light, indicating that the sintered bodies were optically transparent. Optical transmittance of disk #23-245, disk #23-246 and disk #23-247 sintered using sulfurized powders (Ca:La:1:18) are shown in FIG. 5.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A calcium lanthanum sulphide (CLS) composition comprising a crystalline phase selected from the group consisting of CaLa₂S₄, CaLa_{2.3}S₄, CaLa_{2.7}5₄, CaLa_{2.3}S₄₋₄₅, CaLa_{2.7}S_{5.05}, CaLa₁₈S₂₈ and mixture thereof, wherein the molar ratio of calcium to lanthanum is between 1:2.0 and 1:2.8, and 1:18, wherein the composition:
has a mean particle size less than 1 μm,
has a phase purity of at least 98%, and
exhibits infrared transmittance of at least 50% in the 8-14 μm range after densification.

2. The calcium lanthanum sulphide (CLS) composition of claim 1, wherein the infrared transmittance is at least 60% in the 8-14 μm range and at least 65% in the 3-5 μm range.

3. The calcium lanthanum sulphide (CLS) composition of claim 1, wherein the composition has a density of at least 99% of theoretical density, wherein the composition is densified by hot isostatic pressing.

4. The calcium lanthanum sulphide (CLS) composition of claim 1, wherein the composition is substantially free of pores and secondary phases visible under scanning electron microscopy at 5000× magnification.

5. The calcium lanthanum sulphide (CLS) composition of claim 1, wherein the composition consists essentially of CaLa_{2.7}S_{5.05}, wherein the mean particle size is between 0.4 μm and 0.8 μm, a phase purity of at least 99%, an infrared transmittance of 66-68% in the 3-5 μm range and 60-68.5% in the 8-14 μm range after densification, wherein the composition is densified to at least 99% theoretical density by hot isostatic pressing.

5. The calcium lanthanum sulphide (CLS) composition of claim 4, wherein the Knoop hardness is at least 600 kg/mm².

6. A method for producing CLS powder comprising:
dissolving a lanthanum salt and a calcium salt in water to form a solution;
adding a sulfur source to the solution;
heating the solution to a first temperature between 65° C. and 85° C. for at least 3 minutes;
introducing the solution into a furnace preheated to between 450° C. and 550° C. for between 30 minutes to 120 minutes to induce combustion; and
cooling the powder in an oxygen-limited environment to yield a CLS composition comprising a crystalline phase selected from the group consisting of CaLa₂S₄, CaLa_{2.3}S₄, CaLa_{2.7}S₄, CaLa_{2.3}S_{4.45}, CaLa_{2.7}S_{5.05}, CaLa₁₈S₂₈, and mixtures thereof, and wherein the composition:
has a mean particle size less than 1 μm,
has a phase purity of at least 98%, and
exhibits infrared transmittance of at least 50% in the 8-14 μm range after densification.

7. The method of claim 5, wherein the lanthanum salt is lanthanum nitrate hexahydrate, the calcium salt is calcium nitrate tetrahydrate, and the sulfur source is thioacetamide.

8. The method of claim 5, wherein the CLS powders consists essentially of CaLa_{2.7}S_{5.05}.

9. The method of claim 5, wherein the solution is stirred at about 75° C. for about 5 minutes and the furnace is preheated to about 500° C. for about 60 minutes.

10. The method of claim 7, wherein the method further comprises uses a complexant comprising citric acid, EDTA, tartaric acid, or combinations thereof, wherein precipitation pH is maintained between 8.0 and 10.5 and ionic strength is adjusted by 0.05-0.5 M ammonium or alkali salts, and wherein sulfurization is performed with a constant temperature-time profile.

11. The method of claim 10, further comprising adding 0.1-2.0 wt. % silica and/or alumina.

12. An optical component made from calcium lanthanum sulphide (CLS) powders, the CLS powders comprising a crystalline phase selected from the group consisting of CaLa₂S₄, CaLa_{2.3}S₄, CaLa_{2.7}S₄, CaLa_{2.3}S_{4.45}, CaLa_{2.7}S_{5.05}, CaLa₁₈S₂₈, and mixture thereof, and wherein the composition:
has a mean particle size less than 1 μm,
has a phase purity of at least 98%, and
exhibits infrared transmittance of at least 50% in the 8-14 μm range after densification.

13. The optical component of claim 12, wherein the optical component is selected from the group consisting of window, dome, or lens for infrared applications.

14. The optical component of claim 12, wherein the optical component is made from hot isostatic pressing, hot pressing, or spark plasma sintering of CLS powders.

15. The optical component of claim 12, wherein the CLS powders consists essentially of CaLa_{2.7}S_{5.05} and the CLS powders has a mean particle size of less than 1 μm.

16. The optical component of claim 15, wherein the optical component has less than 1% scattering loss in the 8-14 μm wavelength range.

17. The optical component of claim 12 wherein the optical component is infrared-transmitting missile dome, wherein the dome withstands thermal shocks of at least 200° C./min without visible damage.
